(19) United States
(12) Patent Application Publication
(10) Pub. No.: US 2022/0067453 A1
(43) Pub. Date: Mar. 3, 2022

(54) ADAPTIVE AND HIERARCHICAL CONVOLUTIONAL NEURAL NETWORKS USING PARTIAL RECONFIGURATION ON FPGA

(71) Applicants: Mohammad Farhadi, Tempe, AZ (US); Yezhou Yang, Phoenix, AZ (US)

(72) Inventors: Mohammad Farhadi, Tempe, AZ (US); Yezhou Yang, Phoenix, AZ (US)

(73) Assignee: Arizona Board of Regents on behalf of Arizona State University, Scottsdale, AZ (US)

(21) Appl. No.: 17/464,069

(22) Filed: Sep. 1, 2021

Related U.S. Application Data
(60) Provisional application No. 63/073,018, filed on Sep. 1, 2020.

(51) Int. Cl. G06K 9/62; G06N 3/04

(52) U.S. Cl. CPC G06K 9/6267; G06N 3/0454; G06K 9/6232

(57) ABSTRACT

Adaptive and hierarchical convolutional neural networks (AH-CNNs) using partial reconfiguration on a field-programmable gate array (FPGA) are provided. An AH-CNN is implemented to adaptively switch between shallow and deep networks to reach a higher throughput on resource-constrained devices, such as a multiprocessor system on a chip (MPSoC) with a central processing unit (CPU) and FPGA. To this end, the AH-CNN includes a novel CNN architecture having three parts: 1) a shallow part which is a light-weight CNN model, 2) a decision layer which evaluates the shallow part's performance and makes a decision whether deeper processing would be beneficial, and 3) one or more deep parts which are deep CNNs with a high inference accuracy.

### RELATED APPLICATIONS

This application claims the benefit of provisional patent application Ser. No. 63/073,018, filed Sep. 1, 2020, the disclosure of which is hereby incorporated herein by reference in its entirety.

### GOVERNMENT SUPPORT

This invention was made with government support under 1750082 awarded by the National Science Foundation. The government has certain rights in the invention.

### FIELD OF THE DISCLOSURE

The present disclosure relates to machine learning, and more particularly to convolutional neural networks.

### BACKGROUND

Recently, convolutional neural networks (CNNs) have been used to achieve great success in image classification and object detection tasks. This success has led researchers to explore deeper models, such as ResNet (152 layers). These models yield high recognition accuracy by stacking repetitive layers and increasing the number of model parameters. This practice is feasible for applications running in big data centers or infrastructures with high performance processing capabilities. However, such complex models are not suitable for real-time and embedded systems due to low energy constraints and limited computing resources.

The constraints of embedded systems have resulted in various approaches, such as alignment of memory and single instruction, multiple data (SIMD) operations to boost matrix operations (93% Top-5 accuracy), specific hardware (e.g., field-programmable gate array (FPGA)) solutions (86.66% Top-5 accuracy), network compression (89.10% Top-5 accuracy), or using cloud computing (network latency should be considered). While these approaches can reduce energy consumption, they fail to retain recognition accuracy while a system faces critical situations. In other words, they reduce the computation overload by trading a large chunk of recognition accuracy off from state-of-the-art performance metrics (which is currently more than 96% Top-5 accuracy).

### SUMMARY

Adaptive and hierarchical convolutional neural networks (AH-CNNs) using partial reconfiguration on a field-programmable gate array (FPGA) are provided. Recently, most research in visual recognition using convolutional neural networks (CNNs) follows a “deeper model with deeper confidence” belief, and therefore uses deeper models to gain a higher recognition accuracy at a heavier computation cost. However, for a large chunk of recognition challenges a system can classify images correctly using simple models or so-called shallow networks. Moreover, CNNs face size, weight, and energy constraints when implemented on embedded devices.

Embodiments described herein implement an AH-CNN to adaptively switch between shallow and deep networks to reach a higher throughput on resource-constrained devices, such as a multiprocessor system on a chip (MPSoC) with a central processing unit (CPU) and FPGA. To this end, the AH-CNN includes a novel CNN architecture having three parts: 1) a shallow part which is a light-weight CNN model, 2) a decision layer which evaluates the shallow part's performance and makes a decision whether deeper processing would be beneficial, and 3) one or more deep parts which are deep CNNs with a high inference accuracy.

An exemplary embodiment provides a method for extracting features from data. The method includes performing a shallow feature extraction of the data using a shallow neural network implemented on a processor; determining whether the shallow feature extraction is sufficient based on a performance of the shallow neural network; and if the shallow feature extraction is not sufficient, performing a first deep feature extraction of the data by partially reconfiguring the processor to implement a first deep neural network.

Another exemplary embodiment provides an AH-CNN. The AH-CNN includes a shallow part for extracting low-level features of input data; a first deep part for extracting high-level features of the input data; and a decision layer. The decision layer is configured to receive a first output from the shallow part; evaluate a performance of the shallow part; determine whether to pass the first output from the shallow part to the first deep part based on the performance of the shallow part; and when it is determined to pass the output from the shallow part to the first deep part, cause a partial reconfiguration of a processor to instantiate the first deep part.

Another exemplary embodiment provides an embedded computing device for adaptively implementing a dynamic neural network. The embedded computing device includes a memory storing data; and a first processor. The first processor is configured to: receive the data from the memory; implement a first neural network configured to perform a first feature extraction at a first confidence level; and when the first confidence level is below a threshold confidence level, partially reconfigure the first processor to implement a second neural network having a distinct architecture from the first neural network, the second neural network being configured to perform a second feature extraction at a second confidence level.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates functional magnetic resonance imaging (fMRI) results from a study, in which different brain behavior of a human vision system (HVS) corresponds to stimulus images from different categories.

FIG. 2 is a schematic diagram of an exemplary implementation of an adaptive and hierarchical convolutional neural network (AH-CNN) on a field-programmable gate array (FPGA).

FIG. 3 illustrates an exemplary layout of a reconfigurable design for the AH-CNN.

FIG. 4 is a graphical representation of a stop ratio for each part of the AH-CNN on CIFAR-10, CIFAR-100, and SVHN datasets.

FIG. 5A is a graphical representation of computation reduction by applying different decision procedures on the CIFAR-10 dataset.

FIG. 5B is a graphical representation of computation reduction by applying different decision procedures on the CIFAR-100 dataset.

FIG. 5C is a graphical representation of computation reduction by applying different decision procedures on the SVHN dataset.

FIG. 6 is a flow diagram illustrating a process for classifying an image.

FIG. 7 is a block diagram of an embedded system suitable for implementing an AH-CNN according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Adaptive and hierarchical convolutional neural networks (AH-CNNs) using partial reconfiguration on a field-programmable gate array (FPGA) are provided. Recently, most research in visual recognition using convolutional neural networks (CNNs) follows a “deeper model with deeper confidence” belief, and therefore uses deeper models to gain a higher recognition accuracy at a heavier computation cost. However, for a large chunk of recognition challenges a system can classify images correctly using simple models or so-called shallow networks. Moreover, CNNs face size, weight, and energy constraints when implemented on embedded devices.

Embodiments described herein implement an AH-CNN to adaptively switch between shallow and deep networks to reach a higher throughput on resource-constrained devices, such as a multiprocessor system on a chip (MPSoC) with a central processing unit (CPU) and FPGA. To this end, the AH-CNN includes a novel CNN architecture having three parts: 1) a shallow part which is a light-weight CNN model, 2) a decision layer which evaluates the shallow part's performance and makes a decision whether deeper processing would be beneficial, and 3) one or more deep parts which are deep CNNs with a high inference accuracy.

I. Introduction

A recent study suggests that the human vision system (HVS) has two stages for conducting visual classification: 1) a shallow primary stage and 2) a decision layer to pick a further processing pathway. The study also supports the theory that the structure of the object representation in the HVS influences the decision layer during visual classification.

Results from another study in the field of neuroscience showed that the response time of the HVS given a specific image as a stimulus differs significantly based on the category that the image belongs to. These results again suggest that the HVS has a decision system which controls processing resources assigned for each image.

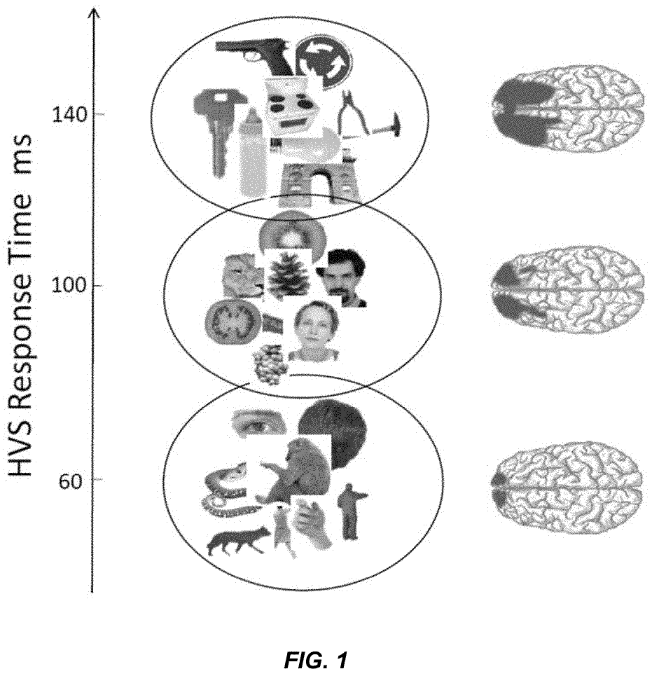

FIG. 1 illustrates functional magnetic resonance imaging (fMRI) results from this study, in which different brain behavior corresponds to images from different categories. From the fMRI imaging, researchers have speculated that for some input image categories only a “shallow” part of the HVS is utilized, while for other categories a “deeper” processing is invoked.

Embodiments described herein apply a machine learning model (e.g., a CNN) to classify images. Following the above insights and observations, a feedback procedure is designed and implemented to determine whether to take an early exit from the model. The core part of this procedure is an engine that accesses an image and predicts how accurate a certain model will perform. The proposed model, besides classifying images, has an extra output which is designed to provide an evaluation on how well a model will perform. The system relies on this evaluation to decide whether classifying a given image with the deeper model will be beneficial or not.

A gate operation is implemented which takes the evaluation and applies an adjustable tolerance threshold for decision making. For example, in autonomous driving scenario, if the class “human” appears in the top 5 or 10 results from a shallow model, the system can adaptively decrease the decision layer threshold and yield a more accurate prediction using deeper models. Thus, the feedback procedure optimizes the resource usage by controlling the type and amount of images being sent to the deeper model.

An implementation of the feedback procedure is provided for determining the path of inference in the CNN based on a confidence level factor. An example embodiment has been implemented on an MPSoC (Pynq-Z1) with an ARM CPU and FPGA. Partial reconfiguration in the FPGA is used to map the quantized CNN on the FPGA resources. Performance of this implementation is demonstrated using ResNet CNNs (as described in K. He, X. Zhang, S. Ren, and J. Sun, “Deep Residual Learning for Image Recognition,” in 2016 IEEE Conference on Computer Vision and Pattern Recognition (CVPR), pages 770-778, 2016) on CIFAR-10, CIFAR-100 (as described in A. Krizhevsky, “Learning Multiple Layers of Features from Tiny Images,” 2009, available at https://www.cs.toronto.edu/˜kriz/learning-features-2009-TR.pdf), and SVHN (as described in Y. Netzer, T. Wang, A. Coates, A. Bissacco, B. Wu, and A. Y. Ng, “Reading Digits in Natural Images with Unsupervised Feature Learning,” 2011, available at http://ufldl.stanford.edu/housenumbers/nips2011_housenumbers.pdf) datasets. The evaluation results show that on average only 69.8%, 71.8%, and 43.8% of computation on the deepest network needs to be utilized for CIFAR-10, CIFAR-100, and SVHN benchmarking datasets, to maintain a comparably high recognition performance.

II. Adaptive and Hierarchical CNNs

The key module of the proposed AH-CNN model is a feedback procedure which is designed to comprehensively evaluate the classification procedure. More specifically, the AH-CNN consists of three parts: 1) a shallow part which is a light-weight CNN model; 2) a decision layer which evaluates the shallow part's performance and makes a decision; and 3) a deep part which is a deep CNN with a high inference accuracy. As mentioned in Section I, the overall objective of this dynamic system is to obtain the highest possible recognition accuracy during critical time instances while maintaining a satisfiable performance using the shallow part during non-critical moments.

Following this intuition, embodiments provide a mechanism with a combination of a shallow model, feedback procedure and one or more deep models, while maintaining a flexible structure. This mechanism can achieve the same high recognition accuracy as other very deep networks by partially reconfiguring the hardware structure. Thus, an intelligent agent equipped with the AH-CNN can adaptively adjust its model structure to maintain a balance between the expected classification accuracy and the model complexity. This procedure can be applied repetitively and has several decision layers. The following section describes the details of the AH-CNN architecture.

A. AH-CNN Architecture

The initial layers in deep neural networks respond to class-agnostic low-level features, while the rear layers extract more specific high-level features. Objects of certain categories can be classified solely by the low-level features, but for other categories more specific high-level features are needed, and deeper layers are needed to extract them. Thus, the AH-CNN architecture is designed to have three modules: the shallow part, the deep part, and a decision layer. Thus, the adaptive and hierarchical structure of the AH-CNN can yield different behaviors based on input data (e.g., input image) characteristics. The three mentioned modules are described further below.

Shallow Part: In an exemplary aspect, the FPGA is loaded with the shallow part first. This part can be applied to the input tensor without any reconfiguration cost and classifies all input images. The shallow part outputs two results: 1) a predicted label y=j and 2) a confidence value (P(y=j|Xᵢ)=softmax(zⱼ)=exp(zⱼ)/Σₖexp(zₖ), where z is the output of fully connected layer over the input image Xᵢ, which will be later used in the feedback procedure.

Deep Part: This part is the next group of convolution layers which should be loaded on the FPGA. Due to the transfer and configuration time, loading the new part on the FPGA is expensive. This group of convolution layers is responsible for extracting more specific high-level features and detecting the images which are misclassified by the shallow part. This part will be applied over the output of the last convolution in the shallow part to reach higher confidence.

Decision Layer: This part of the AH-CNN takes the shallow part's outputs and determines whether to activate the deep part, or simply terminate further processing and take the shallow part's result as the overall model output. This layer has a feedback procedure to make the network behavior decision by evaluating the shallow part.

To this end, the decision layer currently yields a binary behavior based on three factors: 1) the confidence value from the shallow part; 2) the priority of the object classes; and 3) the overall expected classification accuracy (which is obtained by validating the model over the data set). The binary behavior either activates the deep part or takes the shallow part's classification output as the overall model's output.

Algorithm 1 shows the AH-CNN processing procedure in the inference phase. The decision layer first checks the top-n classification results from the shallow part's classification vector. If a label from the high priority set (S_{HP}) exists, there is a higher probability that the input needs further processing. Next, the decision layer checks the current expected classification accuracy, which will affect the fraction of all the input images that need further processing. Finally, the model checks the shallow part's confidence value. The interpretation of the confidence value yields a feedback procedure. The priority of the object classes and the overall expected classification accuracy are then considered to tune a threshold value to compare with the confidence value, which is later referred to as the trigger point.

Algorithm 1 AH-CNN: Inference Phase

```
Require: Input image Xᵢ, Desired accuracy Λ, Number of early branches
  Nᵢ, High priority classes S_{HP}.
  while Xᵢ do
    while Nᵢ do
      Assign proper Γ based on Λ
      β, ShOutput ← ForwardPropagate(Xᵢ, Shallow)
      if S_{HP} appear in ShOutput Top-n then
        Γ = Γ + Θ
      end if
      if β <= Γ then
        Load deep part on FPGA
        Output ← ForwardPropagate((ShOutput, Deep)
      else
        Output ← ShOutput
      end if
    end while
  end while
```

The most critical element of the feedback procedure of the AH-CNN is the trigger point Γ. After feed-forwarding each image over the shallow part, the decision layer gets the confidence value β and compares it with the assigned threshold γ. If β does not reach γ, it means that the shallow part has less confidence than the system's tolerance over the input image and further processing is needed to gain a higher expected accuracy. As a consequence, the decision layer loads and activates the deep part.

The value of the trigger point can be actively adapted according to real-world situations. In cases where high accuracy is not needed, the trigger point value can be decreased. In cases that the member of S_{HP} appears in the top-n outputs, the trigger value (Γ) can be increased by Θ to expect a higher classification accuracy over that image. The trigger point makes the model innately adaptive. How to set a proper trigger point as well as its range is discussed in Section IV-B.

III. Implementation on FPGA

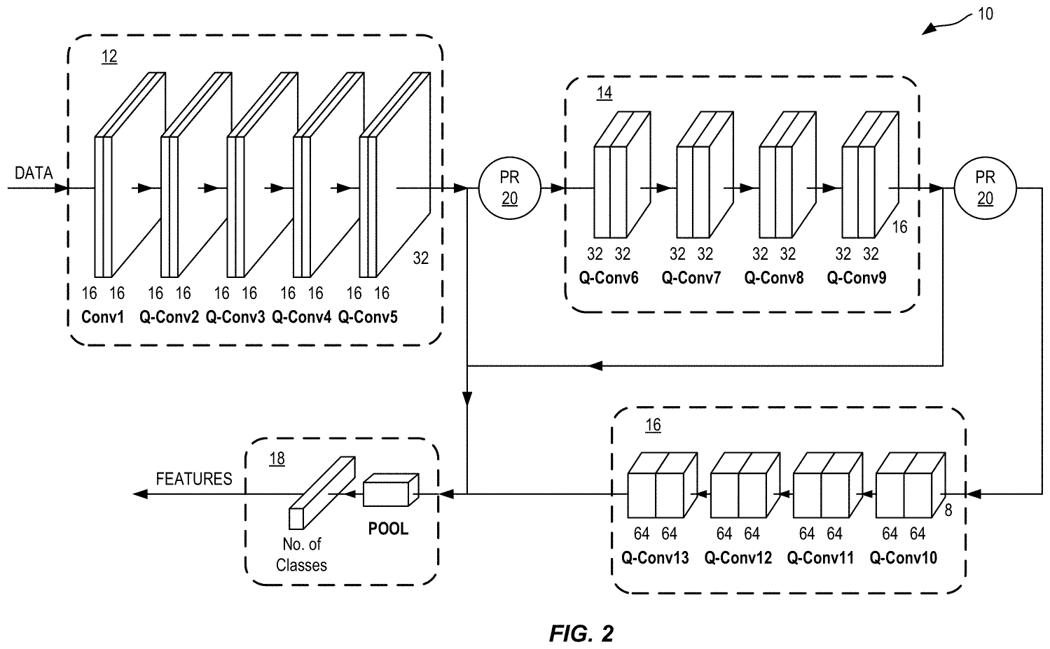

FIG. 2 is a schematic diagram of an exemplary implementation of an AH-CNN 10 on an FPGA. In an exemplary aspect, the convolution layers in the AH-CNN 10 are based on the ResNet CNN structure. The whole AH-CNN 10 is divided into a shallow part 12 and one or more deep parts (e.g., a first deep part 14 and a second deep part 16 as an example, though some embodiments may include only one deep part 14 or additional deep parts). The output of each of the shallow part 12 and the deep parts 14, 16 can be used as the input for a pooling layer in a decision layer 18. There is a partial reconfiguration unit 20 which changes the bitstream file on the FPGA when necessary (e.g., to instantiate one of the deep parts 14, 16). The reason for partial reconfiguration is to save the lookup table (LUT) area on the FPGA and address the limitation of computational resources.

In order to implement the AH-CNN 10 on FPGA, quantized versions of convolution layers (Conv1, Q-Conv2, Q-Conv3, Q-Conv4, Q-Conv5, Q-Conv6, Q-Conv7, Q-Conv8, Q-Conv9, Q-Conv10, Q-Conv11, Q-Conv12, Q-Conv13 in this example) have been used which are popular in the FPGA community. In this network, the weights are binary and the activation data are five bits (quantized bits). Even using this quantization method and binary values, an acceptable accuracy of classification can be obtained which is shown in the evaluation result section (Section IV-B).

Batch processing has been used to improve the overall throughput of the system. During batch processing, the reconfiguration overhead of changing the bitstream files would be considered for all the images that are going to be processed in the network. Therefore, the overhead of reconfiguration would be negligible when calculating the inference time for one image on average.

IV. Training Phase

Both the shallow and the deep part aim to classify images with the best possible performance that can be achieved individually. Consequently, the feedback procedure should not have any influence over the shallow part's classification performance. In an exemplary embodiment, both the deep part and the shallow part are trained using the stochastic gradient mini-batch (as described in J. Dean, G. Corrado, R. Monga, K. Chen, M. Devin, M. Mao, A. Senior, P. Tucker, K. Yang, Q. V. Le, et al, “Large Scale Distributed Deep Networks,” in Advances in Neural Information Processing Systems, pages 1223-1231, 2012). Also, the mean and range of the trigger point value need to be learned from the training data. In the following sections, the overall model learning procedure is first introduced in Section IV-A, and then the training details are described in Section IV-B.

A. Learning Procedure

In the first stage, all parts are trained jointly over training set S_{T} and validated over validation set S_{V}. In each epoch, the accuracy of all parts is evaluated over the validation. The model with the highest accuracy over the deepest part will be selected as the best model due to reaching the best possible accuracy at critical inference time.

Identifying the trigger point: Following the aforementioned design, the shallow part after feed-forwarding each input image has a confidence value over the output belief vector. To have an evaluation over this value and its range, all images from S_{T} are fed into the shallow part and the confidence values are collected. The calculated mean C_{Mean} and the standard deviation C_{Std} over these values are used to control the expected classification accuracy of the AH-CNN.

B. Model Training Details

Initializing: The ResNet-18 model is first adopted as the base model, where each of the blocks in this model is considered as a separate classification module. A pooling and a fully connected layer are added for each part. Xaviar initialization (as described in X. Glorot and Y. Bengio, “Understanding the Difficulty of Training Deep Feedforward Neural Networks,” in Proceedings of the Thirteenth International Conference on Artificial Intelligence and Statistics, pages 249-256, 2010) is used for having proper initial weights to propagate the signals precisely.

Defining the loss function: For a classification task, the cross entropy is mostly used as a loss function. Here, there are several parts which get their input from a previous layer and have independent classification layer output.

Consequently, these parts should be trained jointly. The objective function can be formulated as

L(yŷ, y; θ)=Σ_{N}L(ŷₙ, y; θ)

where

$$L ( {\hat{y}}_{n} , y ; θ ) = \frac{1}{{ζ}_{{S}_{T}}} {Σ}_{k} {y}_{n}^{k} log f ( {x}_{k} ; θ )$$

and N denotes the total number of classification modules, xₖ denotes the input images, ζ denotes the set of all possible labels, and f(θ) denotes the whole model.

V. Evaluation

The theoretical framework presented herein suggests two hypotheses that deserve empirical tests: 1) AH-CNN can perform visual classification with much higher efficiency while maintaining the accuracy; and 2) deep CNN models can be executed on a resource-constrained FPGA using partial reconfiguration. To validate these two hypotheses, the AH-CNN was implemented on Xilinx Zynq-7000 and evaluated on the CIFAR-10, CIFAR-100, and SVHN datasets. For this evaluation, the AH-CNN was implemented as described in Section II, where all convolution parts were implemented as separate hardware intellectual property (IP) cores. Vivado HLS was used to synthesize the IP cores. The training procedure was performed using the PyTorch framework.

A. Implementation

The PYNQ-Z1 was selected to perform the evaluations. This board consists of a Xilinx Zynq-7000 ZC7020 and a dual-core ARM A9 processor. Images were loaded to the convolution IP cores through a Direct Memory Access (DMA) IP core.

The Resnet-18 CNN was adopted as the base model. Due to limited available LUTs on this board, the network was broken into three parts. All parts consist of a group of convolution layers, pooling layers, and fully connected layers. To reduce the reconfiguration time, the last pooling layer and fully connected layer were removed, and a new part was added as described below.

FIG. 2 shows an overview of the model. The shallow part 12 is the shallowest model of this architecture. The first deep part 14 and the second deep part 16 are the deeper blocks for extracting more features. The decision layer 18 is commonly shared by the shallow part 12, the first deep part 14, and the second deep part 16. Table I shows the resources needed for each part and total available resources on the FPGA.

TABLE I
Available resources on the Zynq XC7Z020, in comparison
to used resources by convolution parts

| | Shallow | 1^{st} Deep | 2^{nd} Deep | Decision | |
|---|---|---|---|---|---|
| | Part 12 | Part 14 | Part 16 | Layer 18 | Total |
| BRAM | 81 | 91 | 96 | 31 | 280 |
| DSP | 120 | 96 | 96 | 24 | 220 |
| FF | 15672 | 16647 | 34069 | 9908 | 106400 |

As shown previously, the total hardware resources needed for the whole architecture is more than the available resources over the target device. Moreover, there are shared modules over all convolution parts such as decision layer 18, DMA, etc. Consequently, dynamic partial reconfiguration is applied in order to reduce the reconfiguration time by just changing the convolution parts and keeping the shared modules.

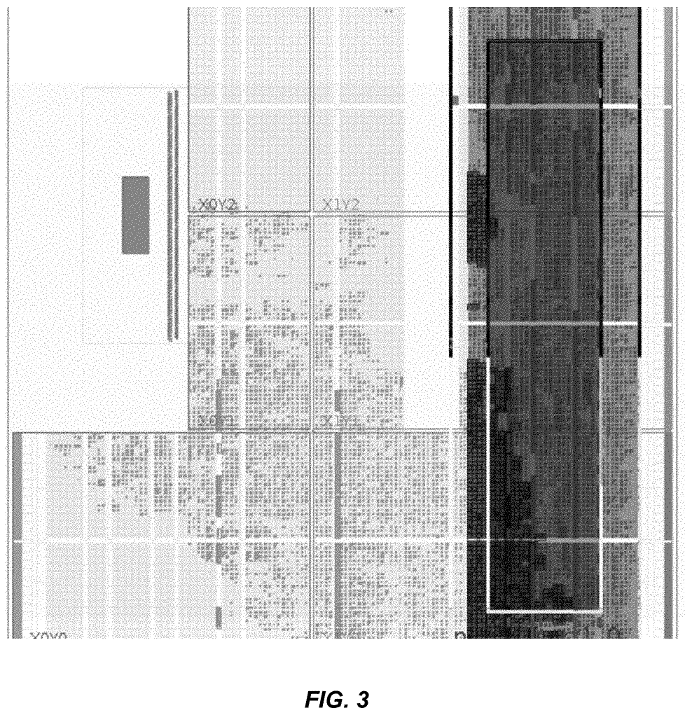

FIG. 3 illustrates an exemplary layout of a reconfigurable design for the AH-CNN implementation. The fixed ports on the FPGA are illustrated in lighter gray, and the reconfigurable area is shown in darker gray. The resulting partial parts have all the same size of 2.4 MB and the size of the main bitstream is 4 MB.

Training: The training part was carried out using PyTorch framework. A special quantized convolution layer and fully connected layer were implemented with 1-bit weight and 5-bit activation. The initial learning rate is set to be 0:01 and it was decreased by a factor of 10 in every 20 epochs. Training continues until 100 epochs with a mini-batch size of 256.

Feedback Evaluation: The procedure in Section IV-B is followed to estimate the confidence value. The mean and the standard deviation of all the confidence values were achieved after the various parts were collected over S_{T}.

B. Overall Evaluation

The CIFAR-10, CIFAR-100, and SVHN validation sets were chosen for the overall AH-CNN model testing. Here, the partial reconfiguration approach is evaluated. Also, three selection methods are compared: 1) the proposed feedback procedure; 2) SkipNet method (as described in E. Bengio, P.-L. Bacon, J. Pineau, and D. Precup, “Conditional Computation in Neural Networks for Faster Models,” arXiv preprint arXiv:1511.06297, 2015); and 3) an entropy-based method (as described in T. Bolukbasi, J. Wang, O. Dekel, and V. Saligrama, “Adaptive Neural Networks for Efficient Inference, in International Conference on Machine Learning, pages 527-536, 2017).

Partial Reconfiguration: There are three accelerator IP cores to reconfigure which are connected to the ARM processor through AXI interface, clocked at 100 MHz. The AXI channel and partial reconfiguration module is controlled by a Python script. A CPU version of AH-CNN architecture is also implemented, which runs on an ARM chip at 666 MHz. Table II shows the measurements of partial reconfiguration, FPGA and CPU execution time. As the reconfiguration region is the same for all IP cores, the reconfiguration time is always the same. By using batch processing (batch=512), the throughput of the system is ≈160 images per second while applying all parts to the images. This is 32 times faster than the CPU implementation.

TABLE II
Performance evaluation on different parts of the design

| | FPGA | FPGA | CPU | |
|---|---|---|---|---|
| | Config | Execution | Execution | |
| Bitstream | Time | Time | Time | FLOPS |
| Shallow Part 12 | 38-42 ms | 2 ms | 98 ms | 10.24M |
| 1^{st} Deep Part 14 | 38-42 ms | 2 ms | 57 ms | 8.6M |
| 2^{nd} Deep Part 16 | 38-42 ms | 2 ms | 49 ms | 8.5M |

Table III shows the accuracy that can be achieved by applying each IP core of convolutions to the input stream. The system can achieve higher accuracy by extracting more feature using deeper layers. Also, a significant portion of images can be classified correctly without using deep layers.

TABLE III
Top-1 accuracy of the HLS optimized IP-cores

CIFAR-100

| | CIFAR-10 | Top1 | Top5 | SVHN |
|---|---|---|---|---|
| Shallow Part 12 | 70.95 | 42.26 | 72.14 | 80.35 |
| 1^{st} Deep Part 14 | 80.57 | 52.23 | 80.25 | 91.24 |
| 2^{nd} Deep Part 16 | 86.27 | 56.60 | 83.46 | 94.62 |

Feedback Procedure: Initially, the trigger point is explored by collecting the confidence of each AH-CNN branch. The AH-CNN model achieves 85:4%, 55:4%, and 94:2% Top-1 validation accuracy over CIFAR-10, CIFAR-100, and SVHN datasets respectively.

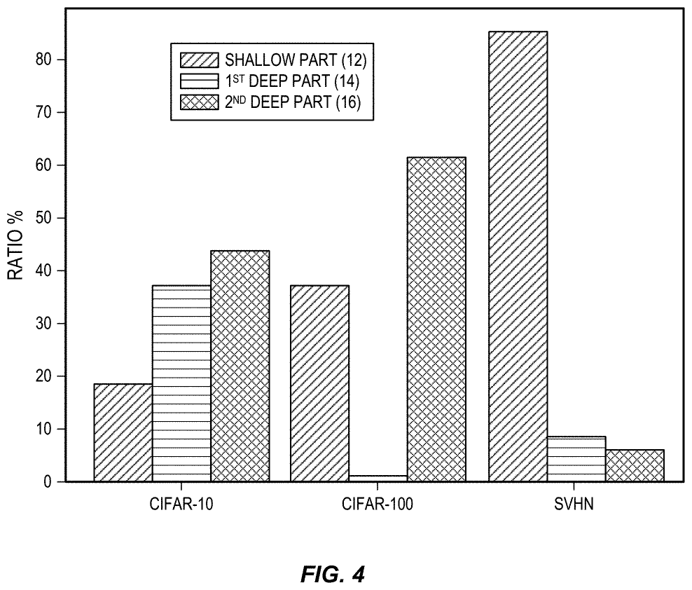

FIG. 4 is a graphical representation of a stop ratio (e.g., the portion of images classified by each branch) for each part of the AH-CNN on CIFAR-10, CIFAR-100, and SVHN datasets. Due to the simplicity of the feedback procedure, this method has the lowest overhead.

SkipNet: In this method, instead of selecting images by the proposed feedback procedure, the decision layer selects images using a gate consisting of convolution and fully connected layers. Two different gates and two training methods (proposed by X. Wang, F. Yu, Z.-Y. Dou, T. Darrell, and J. E. Gonzalez, “Skipnet: Learning Dynamic Routing in Convolutional Networks,” in Proceedings of the European Conference on Computer Vision (ECCV), pages 409-424, 2018) are adopted to evaluate the proposed method. These gates show desirable performance over large CNN models. However, they do not have the same performance over models such as ResNet-18 or ResNet-38. For each decision, one or two convolution layers and a fully connected layer should be applied to the stream.

Entropy Selection: This method uses the entropy of the shallow part's output to decide whether the input image needs further processing or not. The source work implemented two variants: two-stacked model (AlexNet, as described in A. Krizhevsky, I. Sutskever, and G. E. Hinton, “ImageNet Classification with Deep Convolutional Neural Networks,” Advances In Neural Information Processing Systems, pages 1-9, 2012, and ResNet-50) and three-stacked model (AlexNet, GoogleNet, as described in C. Szegedy, W. Liu, Y. Jia, P. Sermanet, S. Reed, D. Anguelov, D. Erhan, V. Vanhoucke, and A. Rabinovich, “Going Deeper with Convolutions,” in Proceedings of the IEEE Conference on Computer Vision and Pattern Recognition, pages 1-9, 2015, and ResNet-50). Due to calculating the entropy of the output vector at each branch, this method is more expensive than the feedback procedure.

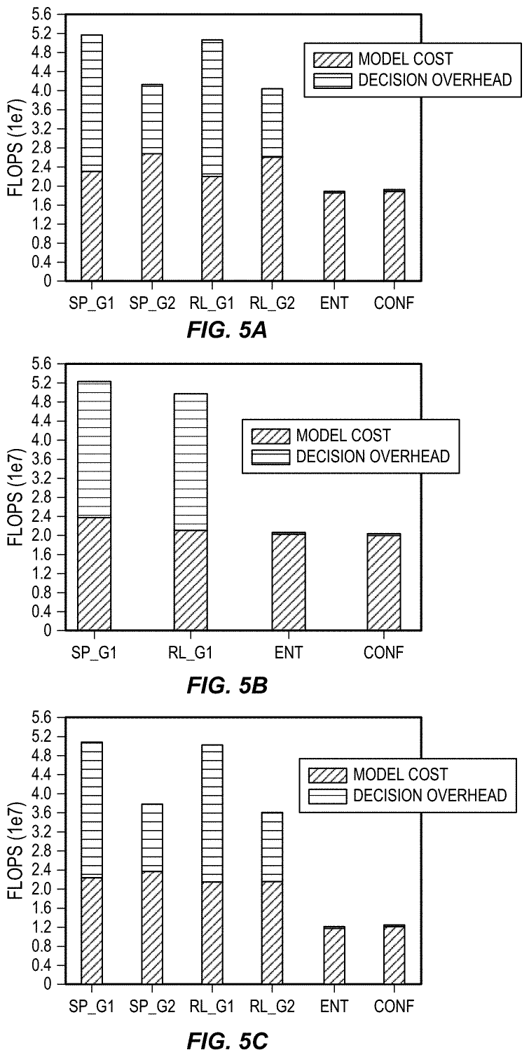

FIG. 5A is a graphical representation of computation reduction by applying different decision procedures on the CIFAR-10 dataset. FIG. 5B is a graphical representation of computation reduction by applying different decision procedures on the CIFAR-100 dataset. FIG. 5C is a graphical representation of computation reduction by applying different decision procedures on the SVHN dataset.

In FIGS. 5A-5C, it can be observed that by just considering the confidence, the proposed model outperforms the SkipNet gates. SkipNet gates not only are expensive but also are not as successful as other methods in the case study. The confidence and entropy selection have the same results; however, the confidence method has less computation cost. The confidence selection method decreased the computation to 69:8%, 71:8%, and 43:8% of the base model in CIFAR-10, CIFAR-100, and SVHN respectively. Also, the throughput of the model reaches 268, 217, and 408 images per second.

VI. Method

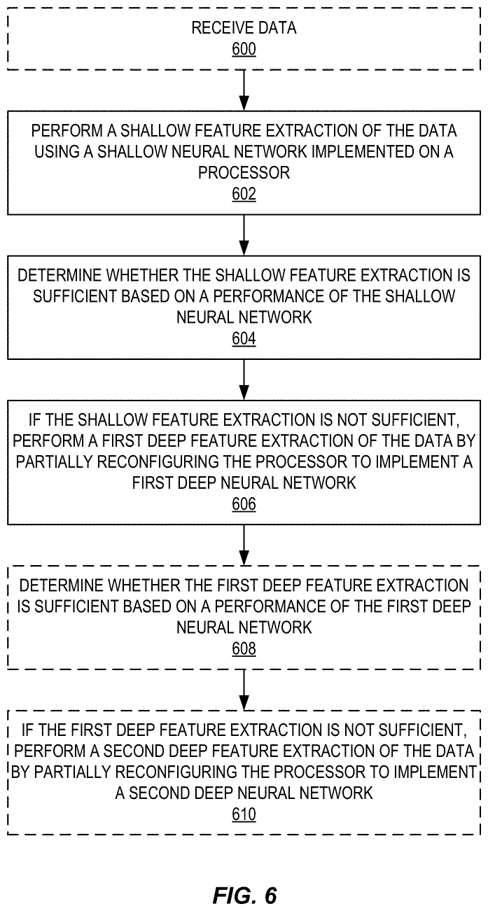

FIG. 6 is a flow diagram illustrating a process for classifying an image. Optional steps are shown in dashed lines. The process may optionally begin at operation 600, with receiving data (e.g., an image). In an exemplary aspect, an image is received and processed in real time to provide a classification or other feature extraction. In some examples, the image is received from a memory. The process continues at operation 602, with performing a shallow feature extraction of the data using a shallow neural network implemented on a processor. In an exemplary aspect, the processor is an FPGA, although it may be another reconfigurable accelerator such as a graphical processing unit (GPU).

The process continues at operation 604, with determining whether the shallow feature extraction is sufficient based on a performance of the shallow neural network. The process continues at operation 606, with, if the shallow feature extraction is not sufficient, performing a first deep feature extraction of the data by partially reconfiguring the processor to implement a first deep neural network.

The process may optionally continue at operation 608, with determining whether the first deep feature extraction is sufficient based on a performance of the first deep neural network. The process may optionally continue at operation 610, with, if the first deep feature extraction is not sufficient, performing a second deep feature extraction of the data by partially reconfiguring the processor to implement a second deep neural network. In this manner, any number of deeper feature extractions may be performed by cascading one or more deep CNNs, each of which may be instantiated by dynamic partial reconfiguration.

Although the operations of FIG. 6 are illustrated in a series, this is for illustrative purposes and the operations are not necessarily order dependent. Some operations may be performed in a different order than that presented. Further, processes within the scope of this disclosure may include fewer or more steps than those illustrated in FIG. 6.

VII. Computer System

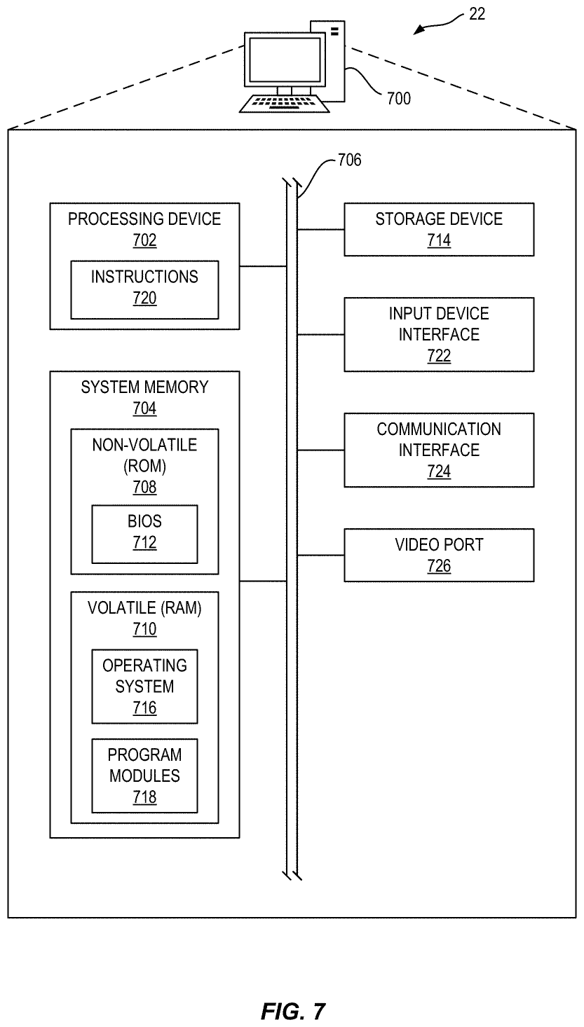

FIG. 7 is a block diagram of an embedded system 22 suitable for implementing an AH-CNN 10 according to embodiments disclosed herein. The embedded system 22 includes or is implemented as a computer system 700, which comprises any computing or electronic device capable of including firmware, hardware, and/or executing software instructions that could be used to perform any of the methods or functions described above, such as classifying an image. In this regard, the computer system 700 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 700 in this embodiment includes a processing device 702 or processor, a system memory 704, and a system bus 706. The system memory 704 may include non-volatile memory 708 and volatile memory 710. The non-volatile memory 708 may include read-only memory (ROM), erasable programmable read-only memory (EPROM), electrically erasable programmable read-only memory (EEPROM), and the like. The volatile memory 710 generally includes random-access memory (RAM) (e.g., dynamic random-access memory (DRAM), such as synchronous DRAM (SDRAM)). A basic input/output system (BIOS) 712 may be stored in the non-volatile memory 708 and can include the basic routines that help to transfer information between elements within the computer system 700.

The system bus 706 provides an interface for system components including, but not limited to, the system memory 704 and the processing device 702. The system bus 706 may be any of several types of bus structures that may further interconnect to a memory bus (with or without a memory controller), a peripheral bus, and/or a local bus using any of a variety of commercially available bus architectures.

The processing device 702 represents one or more commercially available or proprietary general-purpose processing devices, such as a microprocessor, CPU, or the like. More particularly, the processing device 702 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 702 is configured to execute processing logic instructions for performing the operations and steps discussed herein.

In this regard, the various illustrative logical blocks, modules, and circuits described in connection with the embodiments disclosed herein may be implemented or performed with the processing device 702, which may be a microprocessor, FPGA, a digital signal processor (DSP), an application-specific integrated circuit (ASIC), or other programmable logic device, a discrete gate or transistor logic, discrete hardware components, or any combination thereof designed to perform the functions described herein. Furthermore, the processing device 702 may be a microprocessor, or may be any conventional processor, controller, microcontroller, or state machine. The processing device 702 may also be implemented as a combination of computing devices (e.g., a combination of a DSP and a microprocessor, a plurality of microprocessors, one or more microprocessors in conjunction with a DSP core, or any other such configuration). In an exemplary aspect, the AH-CNN 10 is implemented on a first processor, which may be an FPGA with dynamic partial reconfiguration capability. A second processor (e.g., a CPU) may facilitate loading of the AH-CNN 10 and/or evaluation of FPGA output(s).

The computer system 700 may further include or be coupled to a non-transitory computer-readable storage medium, such as a storage device 714, which may represent an internal or external hard disk drive (HDD), flash memory, or the like. The storage device 714 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 716 and any number of program modules 718 or other applications can be stored in the volatile memory 710, wherein the program modules 718 represent a wide array of computer-executable instructions corresponding to programs, applications, functions, and the like that may implement the functionality described herein in whole or in part, such as through instructions 720 on the processing device 702. The program modules 718 may also reside on the storage mechanism provided by the storage device 714. As such, all or a portion of the functionality described herein may be implemented as a computer program product stored on a transitory or non-transitory computer-usable or computer-readable storage medium, such as the storage device 714, volatile memory 710, non-volatile memory 708, instructions 720, and the like. The computer program product includes complex programming instructions, such as complex computer-readable program code, to cause the processing device 702 to carry out the steps necessary to implement the functions described herein.

An operator, such as the user, may also be able to enter one or more configuration commands to the computer system 700 through a keyboard, a pointing device such as a mouse, or a touch-sensitive surface, such as the display device, via an input device interface 722 or remotely through a web interface, terminal program, or the like via a communication interface 724. The communication interface 724 may be wired or wireless and facilitate communications with any number of devices via a communications network in a direct or indirect fashion. An output device, such as a display device, can be coupled to the system bus 706 and driven by a video port 726. Additional inputs and outputs to the computer system 700 may be provided through the system bus 706 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for extracting features from data, the method comprising:
performing a shallow feature extraction of the data using a shallow neural network implemented on a processor;
determining whether the shallow feature extraction is sufficient based on a performance of the shallow neural network; and
if the shallow feature extraction is not sufficient, performing a first deep feature extraction of the data by partially reconfiguring the processor to implement a first deep neural network.

2. The method of claim 1, wherein determining whether the shallow feature extraction is sufficient is based on a confidence value of the shallow feature extraction.

3. The method of claim 2, wherein determining whether the shallow feature extraction is sufficient is further based on a priority of object classes.

4. The method of claim 2, wherein determining whether the shallow feature extraction is sufficient is further based on an expected classification accuracy.

5. The method of claim 1, further comprising:
determining whether the first deep feature extraction is sufficient based on a performance of the first deep neural network; and
if the first deep feature extraction is not sufficient, performing a second deep feature extraction of the data by partially reconfiguring the processor to implement a second deep neural network.

6. The method of claim 1, wherein partially reconfiguring the processor to implement the first deep neural network comprises using a dynamic reconfiguration of a field-programmable gate array (FPGA) at runtime.

7. An adaptive and hierarchical convolutional neural network (AH-CNN), comprising:
a shallow part for extracting low-level features of input data;
a first deep part for extracting high-level features of the input data; and
a decision layer configured to:
receive a first output from the shallow part;
evaluate a performance of the shallow part;
determine whether to pass the first output from the shallow part to the first deep part based on the performance of the shallow part; and
when it is determined to pass the output from the shallow part to the first deep part, cause a partial reconfiguration of a processor to instantiate the first deep part.

8. The AH-CNN of claim 7, wherein the shallow part is configured to output a classification of the input data and a confidence value.

9. The AH-CNN of claim 8, wherein the decision layer is configured to evaluate the performance of the shallow part based on the confidence value received from the shallow part.

10. The AH-CNN of claim 9, wherein the decision layer is configured to evaluate the performance of the shallow part further based on:
a priority of classifications of the input data; and
an expected classification accuracy for the AH-CNN.

11. The AH-CNN of claim 7, further comprising a second deep part for extracting further high-level features of the input data;
wherein the decision layer is further configured to:
receive a second output from the first deep part;
evaluate a performance of the first deep part;
determine whether to pass the second output from the first deep part to the second deep part based on the performance of the first deep part; and
when it is determined to pass the output from the first deep part to the second deep part, cause a partial reconfiguration of the processor to instantiate the second deep part.

12. An embedded computing device for adaptively implementing a dynamic neural network, the embedded computing device comprising:
a memory storing data; and
a first processor configured to:
receive the data from the memory;
implement a first neural network configured to perform a first feature extraction at a first confidence level; and
when the first confidence level is below a threshold confidence level, partially reconfigure the first processor to implement a second neural network having a distinct architecture from the first neural network, the second neural network being configured to perform a second feature extraction at a second confidence level.

13. The embedded computing device of claim 12, wherein the second neural network is cascaded from the first neural network.

14. The embedded computing device of claim 12, wherein the first processor is further configured to, when the second confidence level is below the threshold confidence level, partially reconfigure the first processor to implement a third neural network having a distinct architecture from the first and the second neural networks, the third neural network being configured to perform a third feature extraction at a third confidence level.

15. The embedded computing device of claim 14, wherein:
the second neural network is cascaded from the first neural network; and
the third neural network is cascaded from the second neural network.

16. The embedded computing device of claim 12, wherein the first processor comprises a field-programmable gate array (FPGA).

17. The embedded computing device of claim 16, further comprising a second processor configured to load a shallow part of a convolutional neural network onto the FPGA as the first neural network.

18. The embedded computing device of claim 17, wherein the second processor is further configured to load a deep part of the convolutional neural network onto the FPGA as the second neural network.

19. The embedded computing device of claim 18, wherein loading the deep part of the convolutional neural network onto the FPGA comprises performing dynamic partial reconfiguration of the FPGA.

20. The embedded computing device of claim 12, wherein the first processor comprises a graphical processing unit (GPU).
